(19) United States
(12) Patent Application Publication
(10) Pub. No.: US 2016/0346773 A1
(43) Pub. Date: Dec. 1, 2016

(54) CATALYST CONTAINING HYDROXY METAL OXIDE BINDER AND PROCESS FOR PREPARING

(71) Applicant: UOP LLC, Des Plaines, IL (US)

(72) Inventors: Richard R. Willis, Cary, IL (US); Steven C. Greene, Hampshire, IL (US)

(21) Appl. No.: 14/725,616

(22) Filed: May 29, 2015

(51) Int. Cl. B01J 29/70; B01J 37/08; B01J 37/00; B01J 37/06; B01J 35/08; B01J 37/04

(52) U.S. Cl. CPC B01J 29/7049; B01J 35/08; B01J 37/04; B01J 37/0072; B01J 37/06; B01J 37/08

(57) ABSTRACT

A catalyst composite and a process for preparing the catalyst composite are described. The catalyst composite includes a microporous material having a gallium component dispersed thereon; and a hydroxy metal oxide binder, where the metal is zirconium, titanium, or a mixture thereof. The process includes mixing a gelling agent, water, and the hydroxy metal oxide binder precursor to form a solution. The solution is combined with a microporous material to form a slurry, and the slurry is formed into a shaped article. The article is dried to convert the hydroxy metal oxide binder precursor into a hydroxy metal oxide binder and form the catalyst composite.

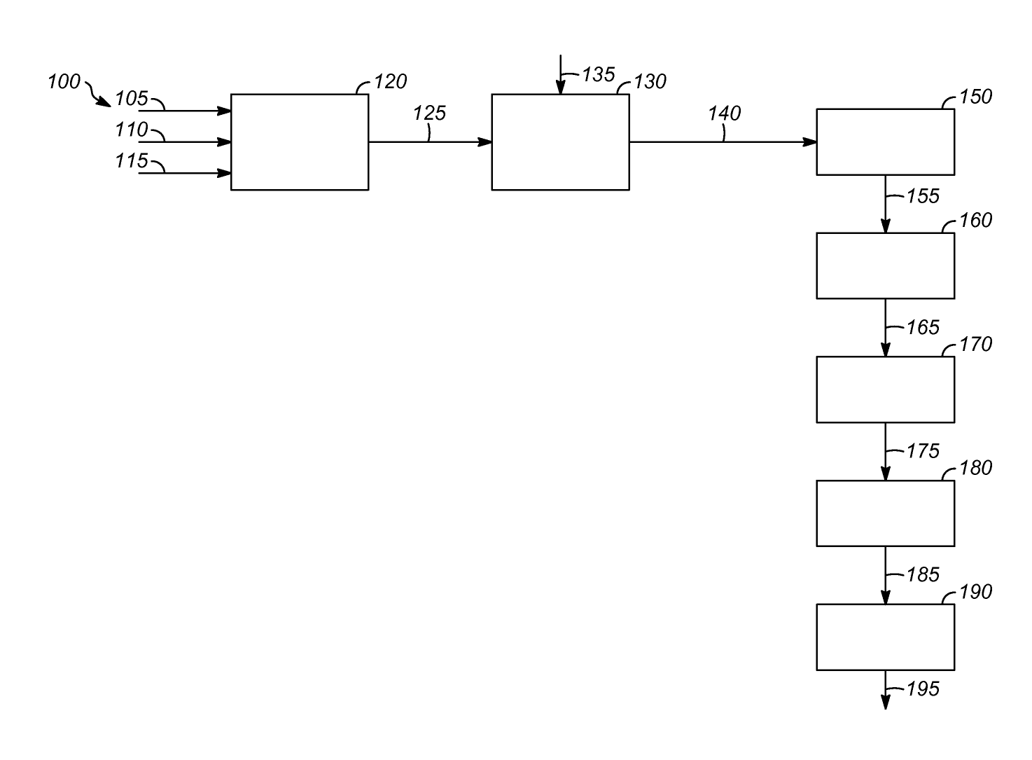

### BACKGROUND

The boom in the natural gas market in the United States has resulted in an increase in the need for conversion of C₂ to C₅ paraffins into products which are more useful and valuable.

One process for doing this is dehydrocyclodimerization, which is a reaction where reactants comprising paraffins and olefins, containing from 2 to 5 carbon atoms per molecule, are reacted over a catalyst to produce primarily aromatics with H₂ and light ends as by-products. The dehydrocyclodimerization reaction results in an aromatic product that always contains more carbon atoms per molecule than the C₂ to C₅ reactants, thus indicating that the dimerization reaction is a primary step in the dehydrocyclodimerization process. Typically, the dehydrocyclodimerization reaction is carried out at temperatures in excess of 260° C. (500° F.) using dual functional catalysts containing acidic and dehydrogenation components. These catalysts include acidic amorphous aluminas which contain metal promoters. Crystalline aluminosilicates have also been successfully employed as catalyst components for the dehydrocylodimerization reaction. Crystalline aluminosilicates generally referred to as zeolites, may be represented by the empirical formula

M_{2/n}Al₂O₃·xSiO₂·yH₂O

in which n is the valence of M which is generally an element of Group I or II, in particular, sodium, potassium, magnesium, calcium, strontium, or barium and x is generally equal to or greater than 2. Zeolites have skeletal structures which are made up of three dimensional networks of SiO₄ and AlO₄ tetrahedra, corner linked to each other by shared oxygen atoms. The greater the proportion of the SiO₄ species to the AlO₄ species, the better suited the zeolite is for use as a component in dehydrocyclodimerization catalysts. Such zeolites include mordenite and the MFI variety. In addition to the zeolite component, certain metal promoters and inorganic oxide matrices have been included in dehydrocyclodimerization catalyst formulations. Examples of inorganic oxides include silica, alumina, and mixtures thereof. Metal promoters such as Group VIII or Group III metals of the Periodic Table, have been used to provide the dehydrogenation functionality. The acidic function can be supplied by the inorganic oxide matrix, the zeolite or both.

Molecular hydrogen is produced in a dehydrocyclodimerization reaction as well as aromatic hydrocarbons. For example, reacting a C₄ paraffin will yield 5 moles of hydrogen for every one mole of aromatic produced. Because the equilibrium concentration of aromatics is inversely proportional to the fifth power of the hydrogen concentration, it is desired to carry out the reaction in the absence of added hydrogen. Adherence to this practice, however, promotes rapid catalyst deactivation and, as a result, short catalyst life expectancy. The rapid deactivation is believed to be caused by excessive carbon formation (coking) on the catalyst surface. This coking tendency makes it necessary to frequently perform costly and time-consuming catalyst regeneration.

One method used to solve the coking problem is to incorporate phosphorus-containing alumina into the catalyst. One example of this type of catalyst is an MFI zeolite bound in a phosphorus-containing alumina (ALPO) binder. The ALPO binder possesses little to no surface acidity, which is an important property for dehydrocyclodimerization catalysts, as well as for certain other catalysts and adsorbents. To make the ALPO binder, an aluminum sol is mixed with phosphoric acid to a mole ratio of about 1:1 to about 100:1 Al:P.

In some processes, such as dehydrocyclodimerization, the catalyst particles must be spherical because they move in the continuous catalytic reforming (CCR) catalyst reactors. One method of preparing the spherical catalyst particles is the oil dropping process. In one example of this process, (a) a crystalline aluminosilicate is mixed with alumina hydrosol, (b) a gelling agent is mixed with a phosphorus compound, (c) the mixtures of (a) and (b) are commingled, (d) the admixture of step (c) is dispersed as droplets in a suspending medium under conditions effective to transform said droplets into hydrogel particles and (e) the hydrogel particles are washed, dried, and calcined to obtain the catalyst composition.

Oil dropping a zeolite in an ALPO binder presents a number difficulties, including the stability of the gelling agent/phosphoric acid solution, the dispersion and milling of MFI in water suspensions, and the use of a low Al/Cl Al sol.

In addition, it has been found that over time in the CCR process, the phosphorus in the binder tends to “migrate” (probably as phosphate) away from the binder and onto the surface of the MFI zeolite. It is possible that is also actually migrating into the zeolite itself, where reaction with aluminum atoms could dealuminate the zeolite and render it less effective for catalysis.

Therefore, there is a need for an improved catalyst.

### SUMMARY OF THE INVENTION

One aspect of the invention is a catalyst composite. In one embodiment, the catalyst composite includes a microporous material having a gallium component dispersed thereon; and a hydroxy metal oxide binder, where the metal is zirconium, titanium, or a mixture thereof.

Another aspect of the invention is a process for preparing a catalyst composite. In one embodiment, the process includes mixing a gelling agent, water, and a hydroxy metal oxide binder precursor to form a solution, wherein the metal is selected from the group consisting of zirconium, titanium and mixtures thereof. The solution is combined with a microporous material to form a slurry, and the slurry is formed into a shaped article. The article is dried at a temperature of about 40° C. to about 200° C. to convert the hydroxy metal oxide binder precursor into a hydroxy metal oxide binder and form the catalyst composite. The microporous material has a gallium component dispersed thereon, which can be done at various points in the process.

### BRIEF DESCRIPTION OF THE DRAWING

The FIGURE is a flow diagram of one embodiment of a process of preparing a catalyst composite.

### DETAILED DESCRIPTION OF THE INVENTION

The present invention relates to a novel catalyst composite and process of preparing it for the dehydrocyclodimerization of C₂ to C₅ aliphatic hydrocarbons and for other similar hydrocarbon conversion reactions. It involves the replacement of the typical ALPO binder system with a hydroxy metal oxide binder, where the metal is zirconium, titanium, or a mixture thereof. The hydroxy metal oxide binder is amorphous and not fully oxidized (e.g., ZrO(OH)₂ or TiO(OH)₂ or mixtures thereof); it is not zirconia (ZrO₂) or titania (TiO₂).

Hydroxy metal oxide binders containing zirconium and/or titanium offer many advantages over ALPO binders. First, they possess no inherent surface acidity. In addition, there is no phosphorus to migrate because they do not contain phosphorus. Moreover, they can be utilized as binders without high temperature calcination, if desired. When they are heat treated at higher temperature, as they would be for most catalysts, they possess reasonable porosity and surface area for effective binding and diffusional characteristics.

With respect to making a catalyst composite using an oil dropping process, the process using hydroxy metal oxide binders containing zirconium and/or titanium offers several important advantages over a process using an ALPO binder. First, such composites can be prepared at a rate at least 14% higher relative to ALPO-based composites. In addition, much less gelling agent is required to neutralize the hydroxy metal oxide binders than the low Al/Cl ratio Al sol plus phosphoric acid mixture, which also means less ammonia will be required in the washing step. The hydroxy metal oxide binder premixes have a much lower viscosity and consequently are easier to pump in a commercial plant. Furthermore, the gelled spheres can be aged (aging is optional) at either atmospheric or elevated pressure, which provides process flexibility. Also, a wide variety of zirconium and/or titanium precursors can be utilized. Moreover, commercial scale processing will be much simpler. With the ALPO binder, phosphoric acid must be diluted before use, and a low Al/Cl Al sol must be made and then blended with HCl before use. In contrast, with the hydroxy metal oxide binder, a metal salt solution can be used with no dilution or other mixing required. Finally, the aluminum sol which would otherwise be needed for this catalyst can be used to make catalysts for other processes.

As illustrated in the FIGURE, the process 100 begins by mixing a hydroxy metal oxide binder precursor 105, a gelling agent 110 (e.g., at a ratio of about 6:1) and water 115 in a mixing zone 120. The water content will vary depending upon the desired formulation (i.e., relative proportion of additive to binder) and upon the nature of the additive itself.

The hydroxy metal oxide binder precursor 105 is a water-soluble zirconium compound, titanium compound, or a mixture of zirconium and titanium compounds. Water-based colloidal suspensions of titanium or zirconium compounds (or mixtures of zirconium and titanium compounds), including, but not limited to, oxides, hydroxides, and hydroxyoxides, can be utilized as well. Suitable solution examples include, but are not limited to, zirconyl chloride, zirconyl nitrate, zirconyl acetate, zirconyl hydroxychloride, zirconium tetrapropoxide, zirconyl oxychloride, zirconyl orthosulfate, zirconyl oxynitrate, titanyl hydroxychloride, titanyl oxychloride, titanyl orthosulfate and titanyl oxynitrate, or combinations thereof. Suitable colloidal examples include amorphous hydrous titanium or zirconium compounds (e.g., titanium oxyhydroxide or zirconium oxyhydroxide) suspensions that can be gelled by, for example, coagulation, pH change, dehydration/concentration change, and/or temperature change.

The gelling agent 110 is typically a weak base which will cause the mixture to set to a gel within a reasonable time, e.g., about 30 seconds to ten minutes at ambient temperature. In this type of operation, ammonia is typically used as a neutralizing or setting agent. Thus, the gelling agent 110 is usually an ammonia precursor. The ammonia precursor is suitably hexamethylenetetramine, or urea, or mixtures thereof. Other weakly basic materials, such as ammonium salts of weak acids, which are substantially stable at normal temperatures, but which decompose to form ammonia with increasing temperature, may also be employed.

The hydroxy metal oxide binder precursor 105 may be present in an amount sufficient to provide about 5 wt % to about 95 wt % of hydroxyl metal oxide binder in the finished catalyst composite, or about 10 wt % to about 90 wt %, or about 10 wt % to about 80 wt %, or about 10 wt % to about 70 wt %, or about 10 wt % to about 60 wt %, or about 10 wt % to about 50 wt %, or about 15 wt % to about 50 wt %, or about 20 wt % to about 50 wt %, or about 20 wt % to about 40 wt %. The gelling agent 110 may be present in an amount sufficient to neutralize part of the acidity of the binder, an amount sufficient to neutralize all of the acidity of the binder, or an amount in excess of the amount to neutralize all of the acidity of the binder. It is understood that these amounts may vary somewhat. Only a fraction of the gelling agent (e.g., ammonia precursor} is hydrolyzed or decomposed in the relatively short period during which initial gelation occurs.

The mixture 125 of hydroxy metal oxide binder precursor, gelling agent, and water from the mixing zone 120 is sent to a slurry zone 130 where the microporous material 135 is added, and a slurry is formed.

Almost any microporous (material with a pore diameter less than 2 nm) or other oxide material could be utilized in the catalyst composite, including, but not limited to, molecular sieves, zeolites, metal-organic frameworks and related materials, activated carbons, amorphous mixed metal oxides, clays and related materials, organic resins, polymers, and polymeric membranes. As mentioned above, crystalline aluminosilicate zeolites have been successfully employed as components in dehydrocyclodimerization catalysts. One suitable family of crystalline aluminosilicates has silica to alumina ratios of at least 12. In some embodiments, the crystalline aluminosilicate zeolite is an MFI crystalline aluminosilicate zeolite. A particularly preferred family is the one identified as the ZSM variety. Included among this ZSM variety are ZSM-5, ZSM-8, ZSM-11, ZSM-12, ZSM-35, and other similarly behaving zeolites. It is most preferred that ZSM-5 be utilized as the crystalline aluminosilicate component of the present invention. These MFI type zeolites are generally prepared by crystallizing a mixture containing a source of alumina, a source of silica, a source of alkali metal, water, and a tetraalkylammonium compound or its precursors. Of course, other crystalline aluminosilicates which meet the silica to alumina ratio criteria may be used, such as, faujasites, L-type, mordenites, omega-type, and the like. The relative proportions of the crystalline aluminosilicate zeolite and the other components of the catalytic composite vary widely with the zeolite content ranging from about 95 wt % to about 5 wt %, or about 90 wt % to about 10 wt %, or about 90 wt % to about 20 wt %, or about 90 wt % to about 30 wt %, or about 90 wt % to about 40 wt %, or about 90 wt % to about 50 wt %, or about 85 wt % to about 50 wt %, or about 80 wt % to about 50 wt %, or about 80 wt % to about 60 wt % of composite.

The slurry 140 from the slurry zone 130 is formed into a shaped article in shaping zone 150. The catalytic composite of the instant invention may be shaped into any useful form, such as, extrudates, beads, spheres, pills, cakes, powders, granules, tablets, etc., and utilized in any desired size. Formation usually occurs during the compositing of the catalytic components, following any known method in the art.

One suitable shape is spheres, which can be manufactured by the well-known oil drop method. The slurry is dispersed as droplets into an oil bath maintained at elevated temperatures. The droplets of the mixture remain in the oil bath until they set and form hydrogel spheres. The spheres are continuously withdrawn from the oil bath. They may be subjected to specific aging treatments to further improve their physical characteristics, if desired.

The shaped articles 155 can be sent to an optional aging zone 160. In the optional aging process, the residual ammonia precursor retained in the spheroidal particles continues to hydrolyze and effect further polymerization of the hydrogel whereby desirable pore characteristics are established. Aging of the hydrogel is suitably accomplished over a period of from about 1 to about 48 hours, preferably in the oil suspending medium, at a temperature of from about 60° C. to about 150° C. or more, and at a pressure to maintain the water content of the hydrogel spheres in a substantially liquid phase. The aging of the hydrogel can also be carried out in aqueous NH₃ solution at about 95° C. for a period up to about 6 hours.

Following the optional aging step, the shaped articles 165 may be washed with hot water containing ammonia in washing zone 170. The primary role of this upflow processing step is to displace most of the oil present during the forming and aging steps from the spheres. The composition of the hot water can also be adjusted to aid in removal of undesired ionic species. For example, ammonia addition is utilized for substantial anion removal.

The washed shaped articles 175 are then dried at a temperature of about 40° C. to about 200° C. to convert the hydroxy metal oxide binder precursor into a hydroxy metal oxide binder and form the catalyst composite in drying zone 180.

The resulting catalyst composite can optionally be subjected to a mild heat treatment step at a temperature of about 150° C. to about 450° C. for a period of about 1 to about 20 hours in the heat treatment zone 190 to produce the catalyst composite 195.

In some embodiments, the catalyst composite contains a gallium component. This component may be present in any form including elemental metal, oxide, hydroxide, halide, oxyhalide, aluminate, or in chemical combination with one or more of the other ingredients of the catalytic composite. Although it is not intended to restrict the present invention by this explanation, it is believed that the best results are obtained when the gallium component is present in the catalyst composite in the zero valence state. This gallium component can be used in any amount which is catalytically effective, with good results obtained with about 0.001% to about 5% gallium by weight of the total catalytic composite on an elemental basis. Best results are ordinarily achieved with about 0.1 wt % to about 1 wt. % gallium, or about 0.5 wt % to about 1 wt. % gallium, calculated on an elemental basis. Although not a necessary condition, it is believed that a substantial portion of the gallium present in the catalyst composite is located in and/or on the crystalline aluminosilicate component.

This gallium component may be incorporated in the catalytic composite in any suitable manner known to the art to result in a relatively uniform dispersion of the gallium, such as, by ion exchange, co-gelation, or impregnation after, before, or during the compositing of the catalyst formulation. The gallium component can be dispersed on the crystalline aluminosilicate zeolite before combining the solution with crystalline aluminosilicate zeolite to form the slurry, after forming the slurry into the article and before drying the article, or after drying the article. It is to be noted that it is intended to include within the scope of the present invention all conventional methods for incorporating and simultaneously uniformly distributing a metallic component in a catalytic composite and the particular method of incorporation used is not deemed to be an essential feature of the present invention. One suitable method of incorporating the gallium involves ion exchange of the crystalline aluminosilicate with a soluble compound of gallium, such as, gallium tribromide, gallium perchlorate, gallium trichloride, gallium hydroxide, gallium nitrates, gallium oxalate, and the like compounds.

One example of a process in which the present catalyst composite can be used if dehydrocyclodimerization. The dehydrocyclodimerization conditions which will be employed for use with the catalyst composition will vary depending on such factors as feedstock composition and desired conversion. A desired range of conditions for the dehydrocyclodimerization of C₂-C₅ aliphatic hydrocarbons to aromatics include a temperature from about 350° C. to about 650° C., a pressure from about 101 kPa to about 2026 kPa (about 1 to about 20 atmospheres), and a liquid hourly space velocity from about 0.2 to about 5 hr⁻¹. In some embodiments, the process conditions are a temperature in the range from about 400° C. to 550° C., a pressure in or about the range from about 203 kPa to about 1013 kPa (about 2 to about 10 atmospheres), and a liquid hourly space velocity of between about 0.5 to about 2.0 hr⁻¹. It is understood that, as the average carbon number of the feed increases, a temperature in the lower end of the temperature range is required for optimum performance, and conversely, as the average carbon number of the feed decreases, the required temperature is higher.

The feed stream to the dehydrocyclodimerization process is defined herein as all streams introduced into the dehydrocyclodimerization reaction zone. Included in the feed stream is the C₂-C₅ aliphatic hydrocarbon. By C₂-C₅ aliphatic hydrocarbons is meant one or more open, straight or branched chain isomers having from about two to five carbon atoms per molecule. Furthermore, the hydrocarbons in the feedstock may be saturated or unsaturated. Preferably, the hydrocarbons C₃ and/or C₄ are selected from isobutane, normal butane, isobutene, normal butene, propane and propylene. Diluents may also be included in the feed stream. Examples of such diluents include hydrogen, nitrogen, helium, argon, neon, CO, CO₂, and H₂O or its precursors. Water precursors are defined as those compounds which liberate H₂O when heated to dehydrocyclodimerization reaction temperatures.

The feed stream is contacted with the catalytic composite in a dehydrocyclodimerization reaction zone maintained at dehydrocyclodimerization conditions. This contacting may be accomplished by using the catalytic composite in a fixed bed system, a moving bed system, a fluidized bed system, or in a batch type operation; however, in view of the danger of attrition losses of the valuable catalyst and of well known operational advantages, fixed bed systems or dense-phase moving bed systems, such as shown in U.S. Pat. No. 3,725,249, are preferred. It is contemplated that the contacting step can be performed in the presence of a physical mixture of particles of the catalyst composite of the present invention and particles of another dehydrocyclodimerization or similarly behaving catalyst of the prior art.

In a fixed bed system or a dense-phase moving bed system, the feed stream is preheated by any suitable heating means to the desired reaction temperature and then passed into a dehydrocyclodimerization zone containing a bed of the catalytic composite. The dehydrocyclodimerization zone may be one or more separate reactors with suitable means therebetween to assure that the desired conversion temperature is maintained at the entrance to each reactor. It is also important to note that the reactants may be contacted with the catalyst bed in either upward, downward, or radial flow fashion. In addition, the reactants may be in the liquid phase, admixed liquid-vapor phase, or a vapor phase when they contact the catalyst, with the best results obtained in the vapor phase. Thus, the dehydrocyclodimerization system may comprise a dehydrocyclodimerization zone containing one or more fixed or dense-phase moving beds of the instant catalytic composite. In a multiple bed system, the present catalyst composite may be used in less than all of the beds with another dehydrocyclodimerization or similarly behaving catalyst being used in the remainder of the beds. This dehydrocyclodimerization zone may be one or more separate reactors with suitable heating means therebetween to compensate for any heat loss encountered in each catalyst bed. Specific to the dense-phase moving bed system, it is common practice to remove catalyst from the bottom of the reaction zone, regenerate it by conventional means known to the art, and then return it to the top of the reaction zone.

The following example will serve to illustrate certain specific embodiments of the herein disclosed invention. This example should not, however, be construed as limiting the scope of the invention as set forth in the claims as there are many variations which may be made thereon without departing from the spirit of the invention, as those of skill in the art will recognize.

### EXAMPLE

Water (217 g) was added to a solution of 60 g of 40 wt % solution of hexamethylenetetramine (HMT) and chilled to 10 to 15° C. This chilled solution of HMT was then added to a chilled solution of zirconyl hydroxynitrate (ZHN, 366 g). An MFI zeolite (214 g) was added to the chilled mixture of ZHN/HMT to form a pre-dropping mixture. The resultant slurry was dropped into an oil tower maintained at 100° C. Spheres measuring 1 mm in diameter were removed from the bottom of the tower, aged at 95° C. for 2 hours in oil, washed with an ammoniated wash solution at 95° C., and dried at 95° C. for six hours.

As used herein, the term about means within 10% of the value, or within 5%, or within 1%.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed:

1. A catalyst composite comprising:
a microporous material having a gallium component dispersed thereon; and
a hydroxy metal oxide binder, where the metal is zirconium, titanium, or a mixture thereof.

2. The catalyst composite wherein the microporous material comprises a crystalline aluminosilicate zeolite.

3. The catalyst composite of claim 2 wherein the crystalline aluminosilicate zeolite is an MFI crystalline aluminosilicate zeolite.

4. The catalyst composite of claim 1 wherein the gallium is present in an amount of about 0.001 wt % to about 5.0 wt % of the catalyst composite.

5. The catalyst composite of claim 1 wherein the hydroxyl metal oxide binder is present in an amount of about 5 wt % to about 95 wt % of the catalyst composite.

6. The catalyst composite of claim 1 wherein the catalyst composite is in the form of an extrudate, beads, spheres, pills, cakes, powders, granules, tablets, or combinations thereof.

7. A process for preparing a catalyst composite comprising:
mixing a gelling agent, water, and a hydroxy metal oxide binder precursor to form a solution, wherein the metal is selected from the group consisting of zirconium, titanium and mixtures thereof;
combining the solution with a microporous material to form a slurry;
forming the slurry into a shaped article; and
drying the article at a temperature of about 40° C. to about 200° C. to convert the hydroxy metal oxide binder precursor into a hydroxy metal oxide binder and form the catalyst composite, wherein the microporous material has a gallium component dispersed thereon.

8. The process of claim 7 wherein the gallium component is dispersed on the microporous material before combining the solution with the microporous material to form the slurry.

9. The process of claim 7 wherein the gallium component is dispersed on the microporous material after forming the slurry into the article and before drying the article.

10. The process of claim 7 wherein the gallium component is dispersed on the microporous material after drying the article.

11. The process of claim 7 where the hydroxy metal oxide binder precursor is selected from the group consisting of zirconyl chloride, zirconyl nitrate, zirconyl acetate, zirconyl hydroxychloride, zirconium tetrapropoxide, zirconium acetate solution, zirconyl oxychloride, zirconyl orthosulfate, zirconyl oxynitrate, titanyl hydroxychloride, titanyl oxychloride, titanyl orthosulfate, titanyl oxynitrate, a colloidal suspension of a zirconium compound, a colloidal suspension of a titanium compound, a colloidal suspension of a mixture of a zirconium compound and a titanium compound, or combinations thereof.

12. The process of claim 7 where the hydroxy metal oxide binder precursor is present in an amount sufficient to provide about 5 wt % to about 95 wt. % of hydroxy metal oxide binder in the catalyst composite.

13. The process of claim 7 wherein the article is an extrudate, beads, spheres, pills, cakes, powders, granules, tablets, or combinations thereof.

14. The process of claim 7 wherein the microporous material comprises a crystalline aluminosilicate zeolite.

15. The process of claim 7 wherein the crystalline aluminosilicate zeolite is an MFI crystalline aluminosilicate zeolite.

16. The process of claim 7 wherein the gallium is present in an amount of about 0.001 wt % to about 5.0 wt % of the catalyst composite.

17. The process of claim 7 wherein the gelling agent is hexamethylenetetramine.

18. The process of claim 7 further comprising washing the article before drying the article.

19. The process of claim 7 wherein the article is aged for up to about 48 hours before drying the article.

20. A process for preparing a catalyst composite comprising:
mixing a gelling agent, water, and a hydroxy metal oxide binder precursor to form a solution, wherein the metal is selected from the group consisting of zirconium, titanium and mixtures thereof, wherein the gelling agent is hexamethylenetetramine;
combining the solution with an MFI crystalline aluminosilicate zeolite to form a slurry;
forming the slurry into a shaped article, wherein the article is an extrudate, beads, spheres, pills, cakes, powders, granules, tablets, or combinations thereof;
washing the article; and
drying the article at a temperature of about 40° C. to about 200° C. to convert the hydroxy metal oxide binder precursor into a hydroxy metal oxide binder and form the catalyst composite;
wherein the hydroxy metal oxide binder precursor is present in an amount sufficient to provide about 10 wt % to about 50 wt % of hydroxy metal oxide binder in the catalyst composite, and wherein the MFI crystalline aluminosilicate zeolite has a gallium component dispersed thereon, wherein the gallium is present in an amount of about 0.001 wt % to about 5.0 wt % of the catalyst composite.
